(19) United States
(12) Patent Application Publication
(10) Pub. No.: US 2003/0120812 A1
(43) Pub. Date: Jun. 26, 2003

(54) Remote terminal connection system, remote terminal connection method, and program therefor

(76) Inventor: Tetsuji Nitta, Tokyo (JP)

Correspondence Address: RABIN & CHAMPAGNE, PC, 1101 14TH STREET, NW, SUITE 500, WASHINGTON, DC, 20005, US

(21) Appl. No.: 10/255,942

(22) Filed: Sep. 27, 2002

(30) Foreign Application Priority Data
Dec. 20, 2001 (JP) 387367/2001

(51) Int. Cl. G06F 15/16

(52) U.S. Cl. 709/246

(57) ABSTRACT

The present invention is constituted such that a terminal is not infected by a virus even when connected to an external network and the terminal can also be connected to a business internal network. The present invention comprises a terminal server 13, which is connected to an external network and has an application execution program, and a terminal 14, which is connected to this terminal server 13 and has a GUI. The terminal server 13 executes processing by running an application execution program in accordance with a processing request transmitted from the terminal 14, and transmits the execution result to the terminal 14 after converting this execution result into data suitable for printing.

### BACKGROUND OF THE INVENTION

1. Field of the Invention

The present invention relates to a remote terminal connection system.

2. Description of Related Art

Conventionally, when a computer, which is installed in a business or other organization, is connected to an external network such as the Internet, a configuration has been adopted in which a firewall or a proxy server, or the like, is disposed between the computer and the external network. This firewall or proxy server fulfils the role of preventing a computer virus (referred to simply as a “virus” hereinafter), or a computer worm (referred to simply as a “worm” hereinafter), and so forth, from gaining entry to the computer.

A conventional connection system is shown in FIG. 3.

In FIG. 3, the Internet 51 is connected with a computer (terminal) 54 via a firewall 52 or a virus gateway 55. A proxy server 53 functions as a proxy for the terminal 54 upon receiving requests from the terminal 54 for external access. Further, the proxy server 53 comprises a cache function and also comprises a security function such as packet filtering (a function that prevents unauthorized access to the computer and viruses from gaining entry to same, and the like), and works in conjunction with the firewall 52 or the virus gateway 55 to maintain the security of the terminal 54. The terminal 54, which is a client of the proxy server 53, is connected to the proxy server 53 directly or indirectly via a server or similar (not shown).

The terminal 54 is a personal computer which comprises an electronic mail program, a browser program, a spreadsheet program, and a word processing program, or the like. An operator operates the terminal 54 to access the proxy server 53, and thus downloads and processes varied content from a web page such as a company home page which is posted on the Internet 51. Varied content is business report data, electronic mail received from an outside business partner, electronic mail attachment files, and so forth. The operator is able to cause the content, or the results of processing this content, to be displayed on a display unit of the terminal 54, or to be printed on a printer unit, or is able to edit the content.

To summarize the above, the system shown in FIG. 3 makes it possible to:

(a) access the proxy server 53 by operating the terminal 54;

(b) download content from a web page posted on the Internet 51;

(c) display or print the content and the results of processing the content on the terminal 54;

(c′) edit the content; and

(c″) create and send electronic mail.

In addition, by operating the terminal 54, an operator is able to create documents, process data, access a web page posted on the Internet 51, and create mail and send mail thus created to an outside business partner in the form of electronic mail (also abbreviated simply as “mail” hereinafter).

Conventional computers have been designed such that content, which is supplied from the outside, or the like, is ultimately captured by the terminal 54. That is, such content or the like is captured, via the Internet 51, on a variety of servers and the like that are constitutional elements of the computer system, before ultimately being sent to the terminal 54. Thus, captured content and the like is processed using the terminal 54. Therefore, when a virus or a worm (hereafter, both are treated in combined fashion and appear simply as “virus”) is contained in this content or the like, the virus enters the terminal 54 together with the content, and the original functions of the terminal 54 are damaged by this virus. Hereafter, the entry of a virus to a computer system is sometimes rendered “infected by a virus”. Further, there is also a risk that, when the terminal 54 is infected by a virus, the contents of other electronic files (hereafter also abbreviated simply as “files”), which are stored in the terminal 54, will be compromised against the will of the computer system user.

In recent years, the number of viruses and the variety thereof have increased dramatically, as have the techniques and dexterity by which these viruses enter a computer system. Consequently, computer system users are demanding that defense devices, which find and block the entry of viruses seeking to gain entry, should be improved through compliance with new virus types. As such defense devices, vaccines have been developed which constitute software for detecting the presence of viruses and blocking the entry thereof, and for disabling the effect of these viruses. Measures have been taken to install such vaccines in the firewall 52, the virus gateway 55, or the terminal 54 to thereby prevent entry by a virus to a computer system, and the like. However, since improvements are not possible until after a new kind of virus has appeared and damage has been produced by this virus, defense cannot be provided before damage has occurred.

When a virus enters the terminal 54, damage results, such that files stored in the terminal 54 are compromised, for example. Also, when the terminal 54 also functions as a business terminal within the organization, a virus, which has gained entry, also propagates, via the terminal 54, to other terminals of the organization, thus extending the same damage. In addition, there are also instances where software, which manages the computer system, is disrupted, which in turn creates a serious obstacle to the organization's business.

FIG. 4 is a conceptual view of a conventional business computer system.

Here, a description is provided for a business computer system of a financial institution, which represents one example. A host computer 61, which performs financial transaction processing in the financial institution, has a database 62, in which financial transaction data is recorded, connected thereto. A terminal 64 (shown in the figures as 64a, 64b, 64c, and so forth), which is installed in each of the financial institution's outlets, is connected to the host computer 61 via an internal network 63 constituted from a dedicated communication line network or similar. The terminal 64 is a personal computer (constituting a client) which is operated by clerks or other employees in order to perform processing for a variety of financial transactions such as a deposit or withdrawal, a remittance, or a bank transfer, and the like. In addition, an ATM (Automatic Teller Machine) 65 (shown in the figures as 65a, 65b, 65c, and so forth) is also connected to the host computer 61 via the internal network 63. The ATM 65 is installed in each outlet and the like of the financial institution and is a computer which is operated by the customers themselves in order to perform processing for a variety of financial transactions such as a deposit or withdrawal, a remittance, or a bank transfer, and the like.

Here, the terminal 64 fulfils the same function as the terminal 54 in the computer system shown in FIG. 3. An operator is able to perform processing for a variety of financial transactions by operating the terminal 54, which constitutes a single client. Also, it is possible to reference business report data which has been downloaded from a company home page or similar which is posted on the Internet 51, and electronic mail can be exchanged with customers and business partners, and, consequently, convenience is greatly enhanced. However, when the terminal 54 is infected by a virus, the host computer 61, which is for processing financial transactions in the financial institution, and the database 62, in which financial transaction data is recorded, are then also infected by the virus, and files stored in the host computer 61 and the database 62 are thus compromised.

There have therefore been problems in connecting the terminal 64 of a business computer system, which is for carrying out business processes requiring high security such as those of a financial institution, to the Internet 51.

It is an object of the present invention to provide a remote terminal connection system, which resolves the above problems exhibited by a conventional computer system; which is constituted such that a terminal is not infected by a virus even when connected to an external network; and which permits the terminal to also be connected to a business internal network.

### SUMMARY OF THE INVENTION

The present invention is based on the principle that communication between a terminal server and a terminal is performed by using interface code rather than employing executable program code. Although the terminal has a GUI (Graphical User Interface) or similar, the terminal does not execute applications. The terminal directs only an application execution instruction to the terminal server. The terminal receives only data in a format that has been converted into a display or print driver interface.

For this reason, the remote terminal connection system according to a first aspect of the present invention basically comprises a terminal server and a terminal. The terminal server is connected to an external network and has an application execution program. The terminal is connected to this terminal server and has a GUI. The terminal server executes processing by running the application execution program in accordance with an execution request transmitted from the terminal, and transmits the execution result to the terminal after converting this result into data suitable for printing.

Further, the following processing takes place with respect to a virus that has a function to randomly issue files constituting internal documents to the outside. Electronic mail addressed to an outside party, which has been created using the terminal, is sent to an internal mail server after an electronic mail address of an operator has been appended to this electronic mail (hereafter, electronic mail address is also abbreviated simply as “mail address” or “address”). This electronic mail is thus transmitted to an external mail server using a filter. The external mail server forwards this electronic mail, in accordance with an operator address, to an operator mail box which has been created in a memory unit of a web terminal server. The operator accesses the web terminal server via the terminal to issue an instruction to change the address of the electronic mail in the mail box to the mail address of an external transmission partner. Electronic mail is thus transmitted to an outside partner.

Therefore, the remote terminal connection system according to a second aspect of the present invention comprises a terminal server, a terminal, an external mail server, and an internal mail server. The terminal server has an application execution program and is connected to an external network. The terminal has a GUI and is connected to the terminal server. The external mail server is connected to the external network and the terminal server. The internal mail server is connected to the terminal and the external mail server. Externally addressed electronic mail, which is transmitted from the terminal, is transmitted to the terminal server via the internal mail server and the external mail server, and is transmitted from the terminal server to the external network via the external mail server.

### BRIEF DESCRIPTION OF THE DRAWINGS

The foregoing and other objects, features and advantages of the present invention will be better understood from the following description taken in connection with accompanying drawings, in which:

FIG. 1 is a conceptual view of a remote terminal connection system according to a first embodiment of the present invention;

FIG. 2 is a conceptual view of a remote terminal connection system according to a second embodiment of the present invention;

FIG. 3 is a conceptual view of a conventional business computer system;

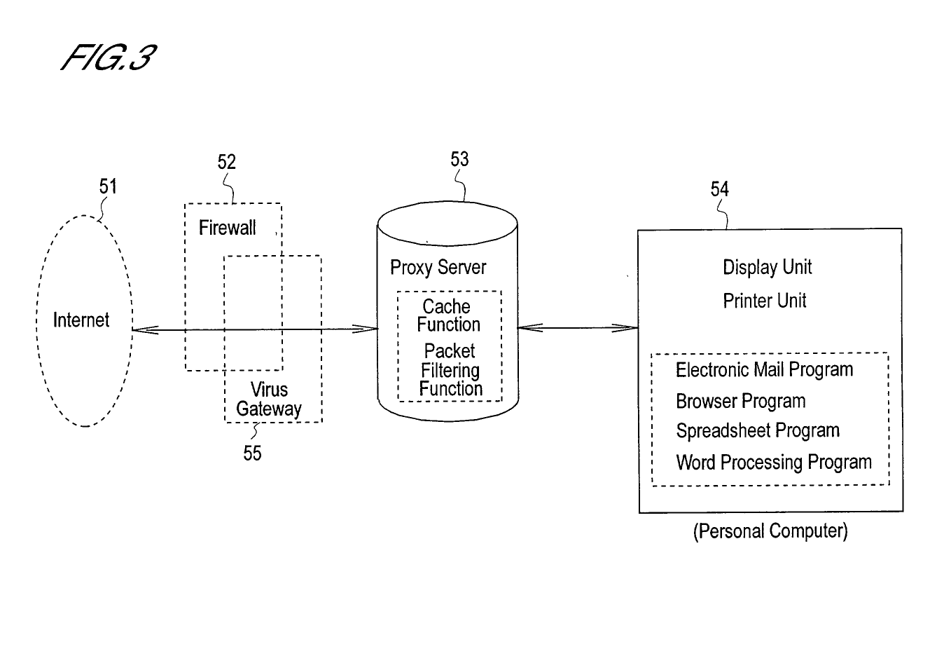

FIG. 4 is a conceptual view of a conventional connection system;

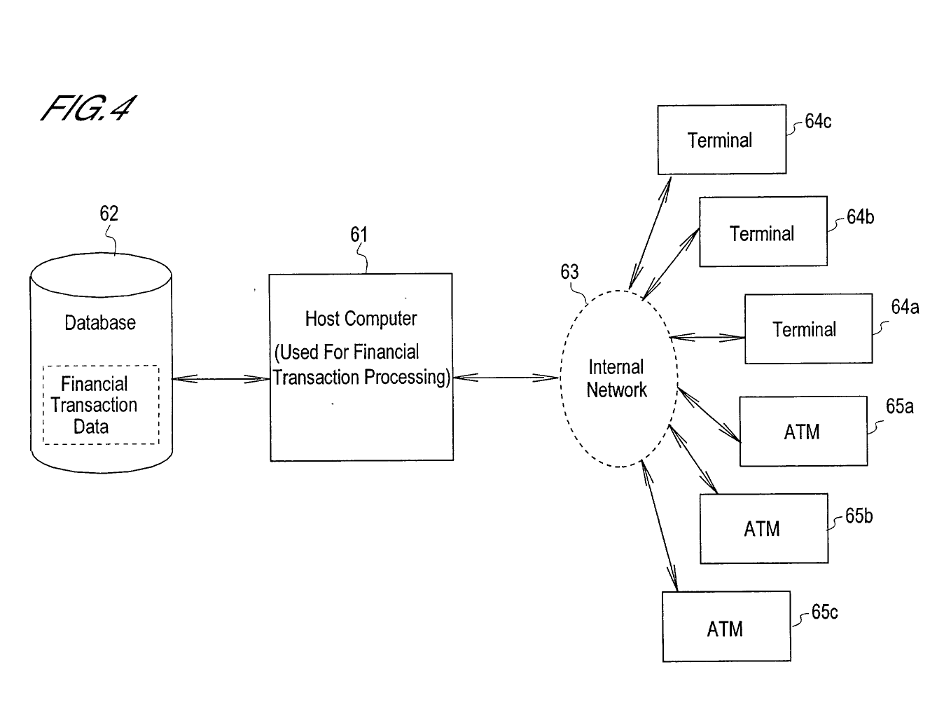

FIG. 5 is a flowchart illustrating a procedure of processing for spreadsheet and document creation, or the like;

FIG. 6 illustrates the flow in which electronic mail addressed to an outside party is created using the terminal, up until this electronic mail is transmitted to an external network;

FIG. 7 is a flowchart illustrating a procedure which is executed by the terminal in order to process viewing data supplied from a customer home page; and

FIG. 8 is a flowchart which, in a case where a customer is notified by means of electronic mail that bank transfer processing, which has been requested by the customer, is complete, illustrates a procedure by which the terminal processes this electronic mail.

### DESCRIPTION OF THE PREFERRED EMBODIMENTS

The embodiments of the present invention will be described in detail hereinbelow with reference to the drawings. The drawings merely serve to conceptually illustrate the constitution of the invention such that same may be understood. Further, the server and other constitutional elements appearing hereinbelow only represent an example. Therefore, the invention is in no way limited to or by these embodiments.

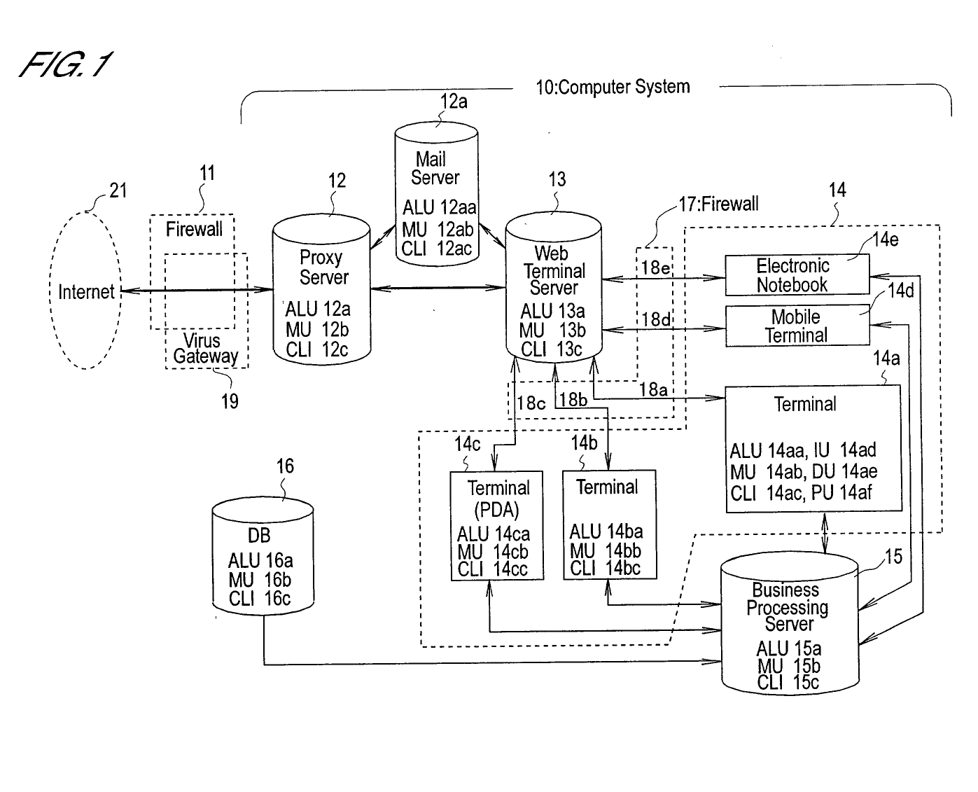

FIG. 1 is a conceptual view of a remote terminal connection system according to a first embodiment of the present invention.

The Internet 21, which constitutes an external network, is connected with a computer system 10 in an organization. This connection is established via a firewall 11 or a virus gateway 19, or the like. The firewall 11 or virus gateway 19 can be seen as a constitutional element of the computer system 10, or may be perceived as being a separate constitutional element of the computer system 10. The firewall 11 or virus gateway 19 is formed by a router or other network device, and by a program, and the like. The condition is established that this router should be accessed from the Internet 21 in order to maintain the security of the computer system 10. In order to illustrate the present embodiment, a financial institution such as a bank or a credit association is presented as being the organization in question. The embodiments of the present invention are not limited to such an institution, it also being possible to direct the present invention toward a store, a manufacturer, or another kind of enterprise, and the present invention can also be directed toward a non-profit organization, an administrative body, a privately owned office, a household, and so forth.

The computer system 10 comprises a proxy server 12. The proxy server 12 is connected to the Internet 21 via the firewall 11 or virus gateway 19. The proxy server 12 is a computer comprising an arithmetic and logic unit such as a CPU (Central Processing Unit) or an MPU (MicroProcessing Unit), a memory unit such as a semiconductor memory or magnetic disk, and a communication link interface, and the like. Further, the proxy server 12 has the following functions and fulfils the following roles:

(a) functions as a proxy for the computer system 10 upon receiving requests from within the computer system 10 for access to'the Internet 21;

(b) comprises a cache function and comprises a security function such as packet filtering; and

(c) works in conjunction with the firewall 11 or the virus gateway 19 to maintain the security of the computer system 10.

Hereafter, the arithmetic and logic unit is abbreviated as ALU, the memory unit as MU, and the communication link interface as CLI.

The proxy server 12 is connected to the server 13. The server 13 is a web terminal server constituting a terminal server and is connected to the proxy server 12. The server 13 comprises an ALU 13a such as a CPU or MPU, an MU 13b such as a semiconductor memory or a magnetic disk, and a CLI 13c, or the like. Furthermore, a terminal 14 (shown in the figures as 14a, 14b, 14c and so forth) is connected to the web terminal server 13 via a firewall 17, and functions as a client of the web terminal server 13. Here, a description is provided with the terminal 14a as the proxy. The terminal 14a is a computer comprising an ALU 14aa such as a CPU or MPU, an MU 14ab such as a semiconductor memory or a magnetic disk, an input unit 14ad such as a keyboard or a mouse, a display unit 14ae such as a CRT (Cathode Ray Tube) or a liquid-crystal display, a printer unit 14af such as a printer, and a CLI 14ac, or the like.

Hereafter, the input unit is abbreviated as IU, the display unit as DU, and the printer unit as PU.

A plurality of terminals 14 is normally installed in each outlet of the bank so that these terminals 14 can be operated by bank clerks, shop employees and so forth, for example. Further, the terminal 14 is ordinarily a computer such as a stationary personal computer but could also be a mobile computer 14b like a laptop computer, a PDA (Personal Digital Assistant) 14c, a mobile terminal 14d, or an electronic notebook 14e, or the like.

A business processing server 15 is connected to the terminal 14. The business processing server 15 is a computer comprising an ALU 15a such as a CPU or MPU, an MU 15b such as a semiconductor memory or a magnetic disk, and a CLI 15c, and processes the business processes of a bank or the like. Furthermore, a database 16 is connected to the business processing server 15. This database 16 is a computer comprising an ALU 16a such as a CPU or MPU, an MU 16b such as a semiconductor memory or a magnetic disk, and a CLI 16c, and has various data, which is for processing the business processes of a bank or the like, recorded thereon.

Meanwhile, besides being directly connected in the manner described hereinabove, the proxy server 12 and the web terminal server 13 can be connected to one another via a mail server 12a. The mail server 12a is a computer comprising an ALU 12aa such as a CPU or MPU, an MU 12ab such as a semiconductor memory or a magnetic disk, and a CLI 12ac. Hence, the mail server 12a is capable of handling electronic mail which is transmitted externally from the computer system 10 via the Internet 21, and electronic mail which is received from the outside via the Internet 21.

When the present invention is directed toward a financial institution such as a credit association, financial transaction data that constitute the financial affairs of a financial organization, are recorded in the database 16. This database 16 is accessed by the business processing server 15 and processing for a variety of financial transactions such as a deposit or withdrawal, a remittance, or a bank transfer, and the like, is executed. Here, the terminal 14 is connected to the business processing server 15 as a client. For example, a bank clerk operates the terminal 14, which is installed in each outlet of the bank, and inputs an execution request for processing for a variety of financial transactions such as a deposit or withdrawal, a remittance, or a bank transfer, and the like. The business processing server 15 accesses the database 16 in accordance with this execution request, and then executes processing for the financial transaction. Ordinarily, a plurality of the business processing servers 15 of the present embodiment is installed.

Further, as already described, in recent years, the number of viruses and the variety thereof have increased dramatically, and the influence of viruses is increasing year by year, as are the techniques and dexterity by which these viruses enter a computer system. For this reason, it has proved difficult to completely prevent entry by viruses even with the use of a firewall 11 or a virus gateway 19. Further, when the terminal 14 also functions as a client for the business processes of a bank or the like, upon becoming infected by such a virus, the terminal 14 then poses a significant obstacle to such business.

Viruses can be broadly classified into 2 types, namely file infection-type viruses, which infect through the medium of program files or similar, and execution-type viruses, which infect through the medium of Excel (registered trademark) macro programs, Java (registered trademark) applet programs, and the like. Also, in a broad classification, there are three routes for the infection, namely via an attachment file of electronic mail, via access to a web page posted on the Internet 21, and via communications in a network. Further, where an attachment file of electronic mail and access to a web page are concerned, infection is by a file infection-type or execution-type virus, and in the case of communications in a network, infection is by an execution-type virus.

Specifically, in any of such cases, a virus enters a computer through the medium of executable program code. Consequently, if interface code which cannot be penetrated by a virus is employed, the computer is not infected by the virus. For example, if data, which is to be transmitted to a partner computer, is transmitted after being converted into image data, the partner computer is not infected by the virus.

Based on this, the present inventors hit upon the idea of causing an application, which is to be executed using the terminal 14, to be executed on the web terminal server 13 and not by the terminal 14, to thereby completely prevent an infection of the terminal 14 by a virus. In other words, an application execution request is transmitted from the terminal 14 to the web terminal server 13, and the web terminal server 13 transmits data to the terminal 14 after converting the data into a format which is generated by converting the execution result of the application execution program into a DU or PU driver interface, in other words, into data suitable for printing. This being so, there is no scope for penetration by a virus into the data suitable for printing, and, as a result, even if the web terminal server 13 is infected by a virus, the terminal 14 is not infected by the virus.

Moreover, the inventors of the present invention hit upon the idea of using the terminal 14 as a client of the business processing server 15. If the business processing server 15 is equipped with all the execution programs for executing the business processing, but the terminal 14 is not provided with any execution programs, the terminal 14 is not infected by a virus. Therefore, even if the terminal 14 is employed as a client of the business processing server 15, the business processing server 15 and the database 16 are not infected by a virus.

Based on such an idea by the inventors of the present invention, in the present embodiment, the terminal 14 is connected to the web terminal server 13 and the business processing server 15, and the terminal 14 is made to function as a client of the web terminal server 13 and the business processing server 15.

Here, the web terminal server 13 has application execution programs such as an electronic mail program, a browser program, a spreadsheet program, a word processing program, a database program, or an office suite program. On the other hand, despite having a GUI, the terminal 14 does not have an application execution program. Consequently, when an operator operates the terminal 14 to execute processing for spreadsheet or document creation, or similar, the operator transmits an execution request from the terminal 14 upon accessing the web terminal server 13, and causes the web terminal server 13 to execute processing by running an application execution program such as a spreadsheet program or a word processing program. The web terminal server 13 then converts a table or document, or the like, which constitutes the execution result of processing, into data suitable for printing, and transmits same to the terminal 14 via the firewall 17. Thus, the table or document, or similar, which constitutes the execution result of processing, is displayed on the DU of the terminal 14, and printed on a print medium by the PU.

The procedure up to printing or displaying as described hereinabove may be summarized as follows:

(a) the operator outputs an application execution request from the terminal 14 to the server 13;

(b) the server 13 converts an execution result into data suitable for printing and transmits same to the terminal 14;

(c) the execution result is displayed on the DU of the terminal 14; and

(c′) the execution result is printed by the PU of the terminal 14.

The same is also true for a case where access is to an external network. In other words, an operator operates the terminal 14 to access a web page such as a home page posted on the Internet 21 by an ASP (Application Service Provider), any given company, administrative body, or the like, and sends a request to the web terminal server 13 to execute processing to receive electronic mail, to download any kind of content including a file, or to view a web page, and so forth. In accordance with this request, the web terminal server 13 executes processing by running an application execution program such as an electronic mail program or a browser program, or the like. Further, the web terminal server 13 converts the execution result of the processing, for example, the contents of an opened electronic mail or file, a viewed web page, or similar, into data suitable for printing, and transmits same to the terminal 14. Thus, the execution result of the processing is displayed on the DU of the terminal 14, and printed on a print medium by the PU. Further, application execution programs are not transferred to the terminal 14 from the web terminal server 13, that is, are not loaded on the terminal 14.

The order of the procedure up to the displaying or printing of a processing result described hereinabove is as follows:

(a) an operator outputs, from the terminal 14, an instruction to receive electronic mail, to download content, or to view a web page, to the server 13;

(b) the server 13 performs processing according to the instruction in (a) by running an electronic mail program or an application execution program;

(c) the server 13 converts the processing result into data suitable for printing and sends same to the terminal 14; and

(d) the processing result is displayed by the DU of the terminal 14 or printed by the PU.

In other words, a method, in which, by means of an instruction from a terminal, a terminal server executes processing for spreadsheet or text processing, or the like, by running an application program, and converts a table or text, or similar, which constitutes the execution result, into data suitable for printing and transmits same to the terminal, comprises:

(a) a step in which the terminal outputs an instruction to run an application program to the terminal server;

(b) a step in which the terminal server, having received the instruction from the terminal, executes processing for spreadsheet or text processing, or the like, by running an application program; and

(c) a step in which the terminal server converts a table or text, or similar, which constitutes the execution result, into data suitable for printing and transmits same to the terminal.

Further, the program for implementing the above method may be described as below, and is namely a remote terminal connection system program for the operation of a remote terminal connection system that comprises a terminal server, which is connected to an external network and has an application execution program, and a terminal, which is connected to this terminal server and has a GUI, which program:

(a) causes the terminal to function as means for issuing an application execution instruction to the terminal server;

(b) causes the terminal server, which has received this instruction, to function as means for executing processing for spreadsheet or document creation, or the like, by running an application execution program; and

(c) causes the terminal server to function as means for converting a table or document, or the like, which constitutes the execution result, into data suitable for printing, and transmitting same to the terminal.

Here, communications 18 (shown as 18a, 18b, 18c, 18d, 18e in the drawings) between the web terminal server 13 and the terminal 14 can be controlled, for example, using commercial remote access software such as Remote Desktop (registered trademark), which is an accessory to Windows 2000 (registered trademark) and Windows XP (registered trademark), or X-Terminal (registered trademark), which is an accessory to Unix (registered trademark). Also, data suitable for printing includes PDF (Portable Document File) or image data, and the like, for example, and is data in a format such that the execution result of processing can be displayed on the DU of the terminal 14, and printed on a print medium by the PU, and can take any form whatever as long as this data does not contain processing executable code.

Therefore, the web terminal server 13 transmits only data suitable for printing, with which there is no scope for penetration by a virus, to the terminal 14, meaning that, if, by any chance, the web terminal server 13 should be infected by a virus, the terminal 14 is not infected by the virus.

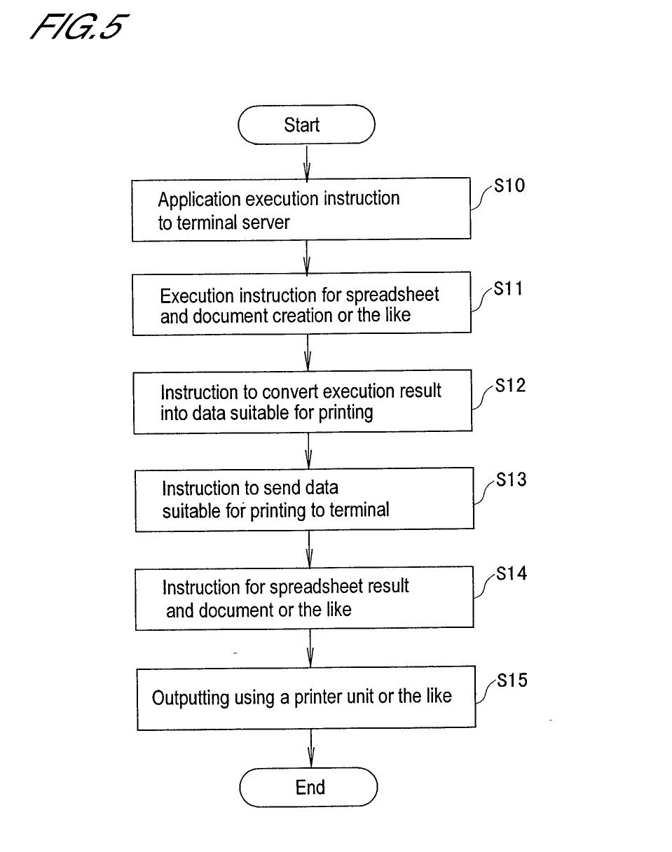

FIG. 5 is a flowchart illustrating a procedure in which the above program is executed by the terminal 14. The terminal 14 instructs the web terminal server 13 to execute an application (step S10), issues an instruction for spreadsheet or text creation, or the like (step S11), and outputs instructions to convert the execution result into data suitable for printing (step S12), and to forward this data to the terminal 14 (step S13). The terminal 14 displays spreadsheet results or text, or the like, as a terminal display screen, based on this data suitable for printing (step S14). According to requirements, the operator outputs the content thus displayed on the display screen by printing this content using the printer unit (step S15).

Next, the operation of the remote terminal connection system will be described.

Here, it is assumed that the organization is a bank, and that the operator is a bank employee. The description is for a case where the operator views a customer home page, acquires data, and executes processing in which a predetermined sum is transferred to a business partner (customer).

First, viewing data, which is supplied from a customer home page, reaches the proxy server 12 via the Internet 21 and after passing through the firewall 11 or virus gateway 19. Then, the viewing data is temporarily stored in the proxy server 12, before being transmitted to the web terminal server 13, and is stored in the MU of the web terminal server 13.

While viewing the display screen of the DU 14ae of a terminal 14, for example, the terminal 14a, the operator operates the IU 14ad to access the web terminal server 13, and transmits a processing request to open the viewing data. In so doing, the web terminal server 13 opens the viewing data by running a program, and, in the ALU 14aa, viewing data is converted into data suitable for printing and is transmitted to the terminal 14a via the CLI 14ac. Thus, the viewing data is displayed on the DU 14ae of the terminal 14a (a first display screen).

Subsequently, processing begins in which the operator grasps viewing data, receives a request from a customer, and transfers a predetermined sum to a business partner (customer). If a Windows system is added to the terminal 14a, the DU 14ae of the terminal 14a is capable of displaying a plurality of windows, that is, is able to display a plurality of screens. Therefore, displaying of viewing data is possible by arranging viewing data within windows. Consequently, upon performing processing to transfer a predetermined sum to a business partner (customer), the operator is able to confirm the viewing data.

The Windows system is a system in which a plurality of screens (windows) are opened on an individual terminal to enable an environment resembling one where work is done with a plurality of documents placed on a desk. Each of the windows functions as one terminal, and is capable of performing separate processing.

Further, the operator operates the IU 14ad of the terminal 14a while viewing the display screen of the DU 14ae, to thereby access the business processing server 15. By means of such access, an execution request to begin bank transfer processing is transmitted to the business processing server 15. In so doing, the business processing server 15 runs a pre-installed business processing program. By running this program, a bank transfer processing input screen opens, and the bank transfer processing input screen is converted, in the ALU 14aa, into data suitable for printing, and transmitted via the CLI 14ac to the terminal 14. The bank transfer processing input screen is thus displayed on the DU 14ae of the terminal 14 as another window (a second display screen).

Thereafter, the operator moves required items, namely the full name of the customer (title), a customer account number, the full name (title) of the bank transfer recipient, the account number of the bank transfer recipient, and the bank transfer sum, and so forth, from among items appearing in viewing data displayed on the DU 14ae of the terminal 14a, from the business processing server 15 to predetermined locations of the bank transfer processing input screen. When these items are thus moved, the terminal 14 copy-and-pastes character strings (the first screen), which are displayed on the display screen of the terminal 14, to the input screen (the second screen) of the business processing server 15 (the same character strings are moved and displayed). Further, the operator operates the terminal 14 to access the business processing server 15, causes the bank transfer processing input screen to be called to and displayed on the DU 14ae of the terminal 14a, and when a transmission is made to the effect that inputting to the bank transfer processing input screen is complete, the business processing server 15 executes bank transfer processing after accessing the database 16.

The flow of the viewing data supplied from a customer home page, as described hereinabove, is ordered as below.

The viewing data is stored in the terminal server 13 after passing from the Internet 21 through the firewall 11 or virus gateway 19 and via the proxy server 12. Subsequent processing is based on the procedure below:

(a) an instruction is sent from the terminal 14 to the server 13 to open viewing data;

(b) the server 13 converts the viewing data into data suitable for printing, and sends same to the terminal 14;

(c) the viewing data is displayed (first screen) on the DU of the terminal 14, and the content of viewing data is thus confirmed by the operator;

(d) an instruction is sent from the terminal 14 to the server 15 to execute bank transfer processing;

(e) the server 15 converts the bank transfer processing input screen into data suitable for printing, and sends same to the terminal 14;

(f) the bank transfer processing input screen is displayed (second screen) on the DU of the terminal 14;

(g) character strings of the display screen of the terminal 14 (first screen) are displayed by moving the same character strings to the input screen of the server 15 (second screen);

(h) the server 15 is notified by the terminal 14 that the inputting to the bank transfer processing input screen is complete; and

(i) the server 15 executes bank transfer processing after accessing the database 16.

Further, a program for executing the above procedure can be a program as described below, that is, a program for processing viewing data supplied from a customer home page, which program:

(a) causes the terminal to function as means for instructing the server to open viewing data;

(b) causes the server to function as means for converting viewing data into data suitable for printing, and for sending same to the terminal;

(c) causes the terminal to function as means for displaying (first display screen) this viewing data on the display unit of the terminal;

(d) causes the terminal to function as means for instructing the server to execute bank transfer processing;

(e) causes the server to function as means for converting the bank transfer processing input screen into data suitable for printing, and for sending same to the terminal;

(f) causes the bank transfer processing input screen to function as means for displaying (second display screen) on the display unit of the terminal;

(g) causes the display unit to function as means for displaying character strings that are the same as character strings of the display screen of the terminal (first display screen) by moving these like character strings to the input screen of the server (second display screen);

(h) causes the terminal to function as means for notifying the server that the inputting to the bank transfer processing input screen is complete; and

(i) causes the server to function as means for executing bank transfer processing after accessing the database.

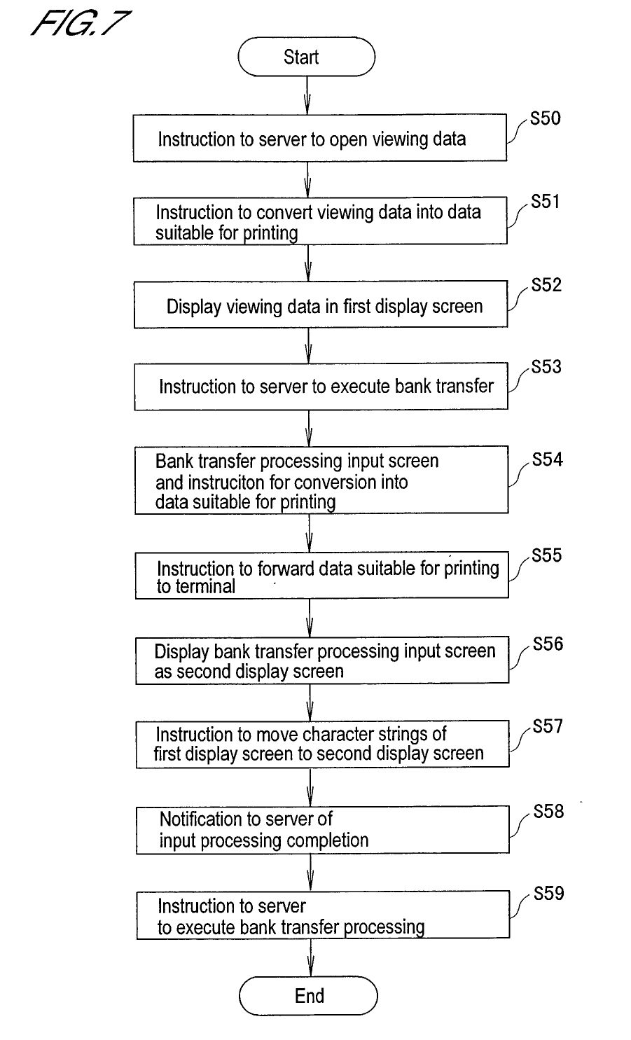

FIG. 7 is a flowchart illustrating a procedure which is executed by the terminal 14 in order to process viewing data supplied from a customer home page. The terminal 14 causes the server to open the viewing data (step S50), and converts this viewing data into data suitable for printing (step S51). After this viewing-data is displayed as the first display screen (step S52), the server is caused to execute bank transfer processing (step S53). Thereafter, after the bank transfer processing input screen is converted into data suitable for printing (step S54), this data is forwarded to the terminal (step S55), and the bank transfer processing input screen is displayed as the second display screen (step S56). Character strings of the first display screen are moved to the second display screen (step S57), and notification to the effect that input processing is complete is sent to the server (step S58). Finally, the terminal 14 instructs the server 15 to execute bank transfer processing after accessing the database 16 (step S59), to thereby complete the serial operation.

Therefore, in the present embodiment, the web terminal server 13, which is connected to the Internet 21, has application execution programs, and, despite having a GUI, the terminal 14 does not have an application execution program. Consequently, when a variety of processing is executed, the web terminal server 13 is accessed from the terminal 14 and an execution request is transmitted therefrom, and processing is then executed by causing the web terminal server 13 to run an application execution program. Further, the execution result of the processing is converted by the web terminal server 13 into data suitable for printing and transmitted to the terminal 14, and displayed on the DU of the terminal 14 and printed on a print medium by the PU.

Therefore, the web terminal server 13 transmits only data suitable for printing, with which there is no scope for penetration by a virus, to the terminal 14, meaning that, if, by any chance, the web terminal server 13 should be infected by a virus, the terminal 14 is not infected by the virus.

Further, in the present embodiment, the description only concerns a case where received data, which is received on the proxy server 12 from a home page on the Internet 21 by the operator, is stored in the MU of the web terminal server 13, and only data suitable for printing is transmitted to the terminal 14, but the same holds true for when electronic mail relating to an enquiry or a bank transfer request, or similar, which has been sent by a customer. In other words, the electronic mail is received by the mail server 12a and is in a form which can be viewed by an operator using an electronic mail program which is stored on the web terminal server 13. Further, the electronic mail is converted into data suitable for printing and transmitted to the terminal 14, by the web terminal server 13.

Thus, even if the electronic mail is infected by a virus, the terminal 14 is not infected by the virus.

Therefore, even if the terminal 14 is operated to access the Internet 21, the terminal 14 is not infected by the virus, and, consequently, the terminal 14 can be made to function as a client of the web terminal server 13 and the business processing server 15 as a result of being connected to the web terminal server 13 and the business processing server 15.

Next, a description is provided of a second embodiment of the present invention. Components having the same structure as those of the first embodiment have been assigned the same reference numerals, and a description of such components has thus been omitted.

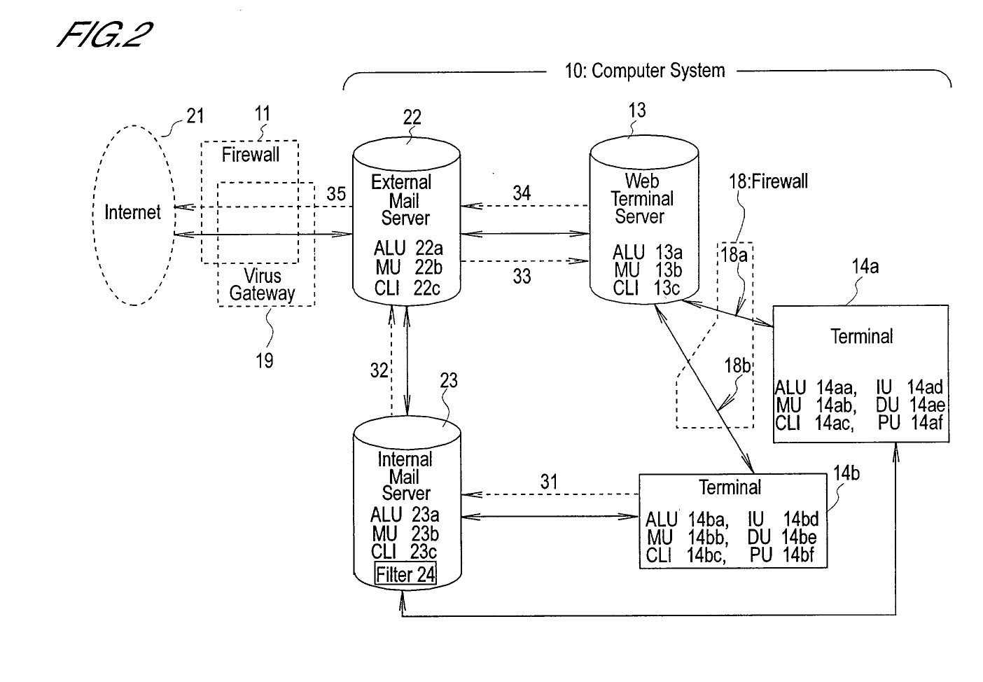

FIG. 2 is a conceptual view of a remote terminal connection system according to a second embodiment of the present invention.

The external mail server 22 is a computer comprising an ALU 22a such as a CPU or MPU, an MU 22b such as a semiconductor memory or a magnetic disk, and a CLI 22c, or the like, and is connected to the Internet 21 and the web terminal server 13. Thus, the external mail server 22 is capable of handling electronic mail which is transmitted externally from the computer system 10 via the Internet 21, and electronic mail which is received from the outside via the Internet 21. Further, the external mail server 22 may also be connected to the Internet 21 via the proxy server 12 described in the first embodiment (not illustrated). Further, the web terminal server 13 is also connected to the Internet 21 via the proxy server 12, such that access to an ASP and to a web page, and so forth, may also be performed via the proxy server 12 (not illustrated).

Further, the internal mail server 23 is a computer comprising an ALU 23a such as a CPU or MPU, an MU 23b such as a semiconductor memory or a magnetic disk, and a CLI 23c, or the like, and handles electronic mail which is exchanged within an organization. Further, the internal mail server 23 is connected to the external mail server 22 and to a multiplicity of the terminal 14 which is installed in the organization. Electronic mail between the terminals 14 is exchanged in its entirety via the internal mail server 23. The internal mail server 23 comprises a filter 24 for transmitting electronic mail, which has had a mail address of an outside party appended thereto, to the external mail server 22. Further, when electronic mail received from the terminal 14 has a mail address of an outside party appended thereto, the filter 24 has a function to compulsorily change this mail address to the mail address of the operator himself (herself).

Further, although the business processing server 15 and the database 16, as described in the first embodiment, have been omitted from FIG. 2, the terminal 14 may also be connected to the business processing server 15.

Indeed, in the present embodiment, the terminal 14 has an electronic mail program, and the operator operates the terminal 14 to create electronic mail, and, depending on the case, to attach a file (files) to this electronic mail, and transmits the electronic mail (and attachment files) from the terminal 14 to the internal mail server 23.

Furthermore, communications 18 (shown as 18a and 18b in the drawings) between the web terminal server 13 and the terminal 14 are controlled using remote access software, as described in the first embodiment, and the web terminal server 13 transmits data suitable for printing, with which there is no scope for penetration by a virus, to the terminal 14, meaning that, if, by any chance, the web terminal server 13 should be infected by a virus, the terminal 14 is not infected by the virus. However, in the present embodiment, the terminal 14 has a function to create electronic mail, to attach files such as spreadsheet files, document files, or the like, to the electronic mail, and, consequently, when the terminal 14 receives electronic mail from another terminal 14, which is installed in parallel with the terminal 14 in the computer system, there is a possibility of the terminal 14 being infected by a virus.

In such a case, a virus that is particularly troublesome is a virus which has a function to externally distribute electronic mail which is to be exchanged only internally and which constitutes an internal document for exchange within the organization, against the will of the operator.

Such a virus extracts a multiplicity of mail addresses which are registered in a mailing list stored on a mail server and randomly issues each electronic mail to these extracted mail addresses. As a result, not only the electronic mail, but also files such as spreadsheet files, document files, and the like, which are to be handled confidentially, are attached to the electronic mail and randomly issued to external mail addresses, which represents a serious problem.

Therefore, in the present embodiment, all electronic mail, which is transmitted having an external address as a result of the operator operating the terminal 14, initially has the mail address of the operator himself (herself) appended thereto. In addition, all electronic mail which is transmitted from the terminal 14, namely both electronic mail transmitted having an external address and also electronic mail transmitted having an internal address is transmitted to the internal mail server 23. Further, only electronic mail which is transmitted having an external address is transmitted to the external mail server 22 using the filter 24 of the internal mail server 23. Consequently, the external mail server 22 transmits the electronic mail to an operator mail box which has been created in the MU 13b of the web terminal server 13, in accordance with the mail address appended to the electronic mail, that is, the mail address of the operator himself (herself) On the other hand, electronic mail, which is transmitted having an internal address, at this point remains as-is in the internal mail server 23.

Therefore, electronic mail, which is transmitted having an external address as a result of the operator operating the terminal 14, is stored automatically in an operator mail box which has been created on the web terminal server 13. Further, the operator operates the terminal 14 to access the web terminal server 13, and transmits a processing request to change the mail address, which has been appended to electronic mail stored in the operator mail box (the operator's own mail address), to a mail address of an external transmission partner. The electronic mail is thus transmitted from the web terminal server 13 to an external transmission partner after the operator's own mail address has been changed to the mail address of the transmission partner.

The procedure for forwarding electronic mail addressed to an outside party as described above is ordered as follows:

(a) the operator creates mail using the terminal 14 and transmits same with the operator's address;

(b) the mail is sent to the internal mail server 23;

(c) the filter 24 selects only mail addressed to an outside party and sends this mail to the external mail server 22;

(d) mail addressed to an outside party is sent from the external mail server to the web terminal server 13 and is stored in an operator mail box in the web terminal server 13;

(e) an instruction to change the mail address from the operator's mail address to the mail address of an external transmission partner is outputted from the terminal 14 to the web terminal server 13; and

(f) mail is sent from the web terminal server 13 to an outside party.

In other words, a method, in which externally addressed electronic mail, which is created using a terminal, is transmitted to a terminal server via an internal mail server and an external mail server, and is then transmitted from the terminal server to an external network via the external mail server, comprising:

(a) a step of creating externally addressed electronic mail in the terminal;

(b) a step in which the internal mail server receives externally addressed electronic mail from the terminal, and sends the electronic mail to the external mail server;

(c) a step in which the external mail server receives externally addressed electronic mail from the internal server, and sends the electronic mail to the terminal server;

(d) a step in which the terminal server receives this externally addressed electronic mail from the external mail server, and sends the electronic mail to the external mail server; and

(e) a step in which the external mail server receives this externally addressed electronic mail from the terminal server and transmits the electronic mail to the external network.

A program to execute the above method may be described as below, and is namely a program for the operation of a remote terminal connection system that comprises a terminal server, which is connected to an external network and a terminal server and has an application execution program; a terminal, which is connected to this terminal server and has a GUI; and an external mail server, which is connected to the terminal server and the external network, which program:

(a) causes a terminal to function as means for creating externally addressed electronic mail;

(b) causes an internal mail server to function as means for receiving this externally addressed electronic mail from the terminal and sending this electronic mail to an external mail server;

(c) causes the external mail server to function as means for receiving this externally addressed electronic mail from the internal server and sending this electronic mail to a terminal server;

(d) causes the terminal server to function as means for receiving this externally addressed electronic mail from the external mail server and sending this electronic mail to an external mail server; and

(e) causes the external mail server to function as means for receiving this externally addressed electronic mail from the terminal server and transmitting this electronic mail to an external network.

The electronic mail, which is transmitted having an internal address as a result of the operator operating the terminal 14, initially has a mail address of an internal party appended thereto, and is transmitted having a mail address which is appended by the operator (the address of somebody within the organization who is a partner to whom the operator is to transmit electronic mail), by the internal mail server 23.

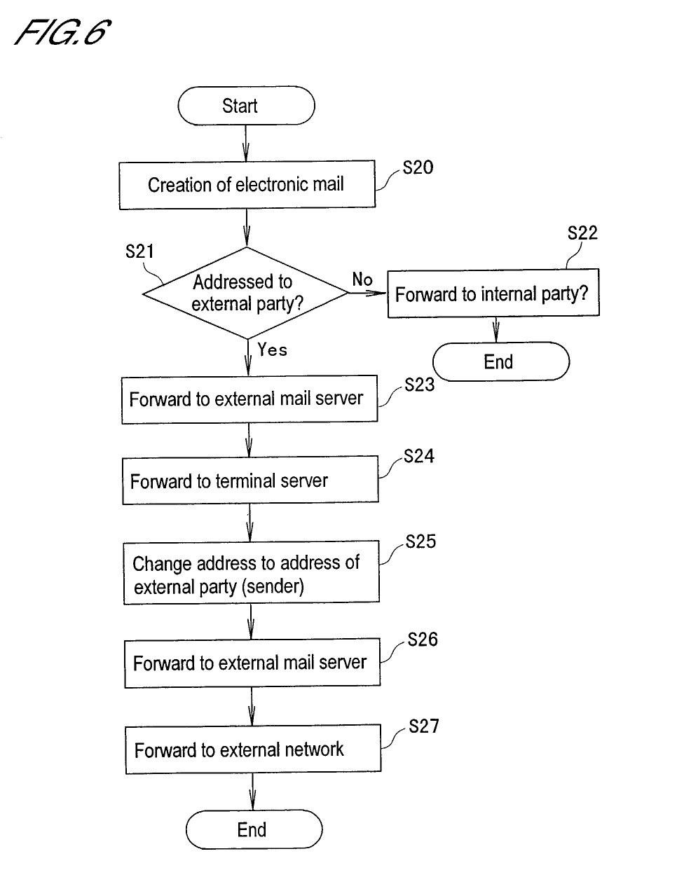

FIG. 6 is a flowchart illustrating the functions by which the terminal 14 executes the above program such that electronic mail addressed to an outside party is created using the terminal 14, up until this electronic mail is transmitted to an external network. Electronic mail is created using the terminal 14 (step S20). If this electronic mail is addressed to an internal party, the address of the internal party is appended thereto, and if this electronic mail is addressed to an outside party, the address of the operator is appended thereto. The terminal 14 sends this electronic mail to the internal electronic mail server 23, and makes the filter 24 within this server judge whether this electronic mail is addressed to an internal party or is addressed to an outside party (step S21). If the electronic mail is addressed to an internal party, the electronic mail is forwarded as-is addressed to the internal party (step S22). If the electronic mail is addressed to an outside party, the electronic mail is sent to the external mail server (step S23). The terminal 14 further sends this electronic mail to the web terminal server 13 (step S24) and causes the address to be changed from the current operator (sender) address to an address of an outside party (receiver) who is the addressee (step S25). Thereafter, the terminal 14 causes the electronic mail to be forwarded to the external mail server 22 (step S26), and then causes this electronic mail to be forwarded to the external network 21 (step S27).

Further, when the electronic mail received from the terminal 14 has a mail address of an outside party appended thereto, the filter 24 has a function to compulsorily change this mail address to the mail address of the operator. Consequently, even in the event of setting, as a result of a virus, to randomly issue electronic mail to external mail addresses, electronic mail is not transmitted directly to the outside, but rather is stored in a mail box of the web terminal server 13. It is therefore possible for an operator to immediately detect the effects of a virus, which makes it possible to provide a suitable defense before a situation arises where electronic mail is issued randomly, addressed to external mail addresses.

A description follows for the operation of a remote terminal connection system with such a constitution.

Here, the description is for a case where the organization is a bank, and the operator is a bank employee, and a customer is notified by electronic mail that bank transfer processing, as requested by the customer, has been executed.

First, the operator operates the terminal 14 to create and transmit electronic mail to the effect that bank transfer processing, as requested by the customer, is to be executed. Here, electronic mail is a reserved electronic mail which is to be transmitted having an external address, and the mail address of an operator at the bank is accordingly appended to the electronic mail. Normally, this is the mail address of an operator at the bank which is made using @ to link a domain name of a bank home page and an account at the bank of an operator at the bank. Further, to simplify the operation, “me” can also be used in place of an account of an operator at the bank. In such a case, the mail address appended to the electronic mail is then “me@XXX.com”, for example.

Thereafter, the electronic mail is transmitted to the internal mail server 23 as shown by the arrow 31 (broken line). Then, the filter 24 of the internal mail server 23 transmits the electronic mail to the external mail server 22 as shown by the arrow 32 (broken line). Here, not only in a case where the appended mail address is “me@XXX.com”, but also in a case where a mail address of an outside party is appended to the electronic mail, the filter 24 changes the mail address to the mail address of an operator at the bank.

Subsequently, the electronic mail is transmitted from the external mail server 22 to the web terminal server 13 as indicated by the arrow 33 (broken line). Next, this electronic mail is stored in an operator mail box which has been created in the MU of the web terminal server 13, in accordance with the mail address thus appended, that is, the mail address of an operator at the bank.

Further, the operator operates the terminal 14 to access the web terminal server 13, and transmits an execution request to change the mail address of electronic mail, which is stored in an operator mail box created in the MU of the web terminal server 13, to a customer mail address. Thus, the mail address appended to the electronic mail is changed to a customer mail address, and transmitted to the external mail server 22 as shown by the arrow 34 (broken line). Further, as shown by the arrow 35 (broken line), the electronic mail is transmitted from the external mail server 22 to the Internet 21 after passing through the firewall 11 or virus gateway 19, and is transmitted to the customer.

The route followed by the electronic mail described hereinabove is ordered as follows:

(a) an operator operates the terminal 14 to create electronic mail;

(b) a mail address of the operator is appended to the electronic mail and same is transmitted;

(c) the electronic mail is transmitted to the internal mail server 23;

(d) the filter 24 of the internal mail server 23 changes the mail address to the mail address of an operator at the bank, not only in a case where the appended mail address is “me@XXX.com”, but also in a case where a mail address of an outside party is appended to the electronic mail, and transmits this electronic mail to the external mail server 22;

(e) the electronic mail is transmitted from the external mail server 22 to the web terminal server 13;

(f) the electronic mail is stored in an operator mail box which has been created in the MU of the web terminal server 13;

(g) the operator operates the terminal 14 to access the web terminal server 13, and transmits an execution request to change the mail address of the electronic mail to a customer mail address;

(h) the appended mail address of the electronic mail is changed to a customer mail address, and the electronic mail is transmitted to the external mail server 22; and

(i) the electronic mail is transmitted from the external mail server 22 to the Internet 21 after passing through the firewall 11 or virus gateway 19, and is transmitted to a customer.

Therefore, the program:

(a) causes the terminal to function as means for creating electronic mail which is transmitted having an operator electronic mail address appended thereto;

(b) causes the internal mail server to function as means for receiving the electronic mail;

(c) causes the filter to function as means for changing the mail address to the mail address of an operator at the bank, not only in a case where the appended mail address is “me@XXX.com”, but also in a case where a mail address of an outside party is appended to the electronic mail, and for transmitting this electronic mail to the external mail server;

(d) causes the external mail server to function as means for transmitting this electronic mail to the web terminal server;

(e) causes the memory unit in the web terminal server to function as means for storing this electronic mail;

(f) causes the web terminal server to function as means for changing the address of the electronic mail to a customer address, in accordance with an instruction from the terminal, and causes the web terminal server to function as means for transmitting this electronic mail, which has had this address changed, to the external mail server; and

(g) causes the external mail server to function as means for transmitting this electronic mail to the customer through a firewall or a virus gateway.

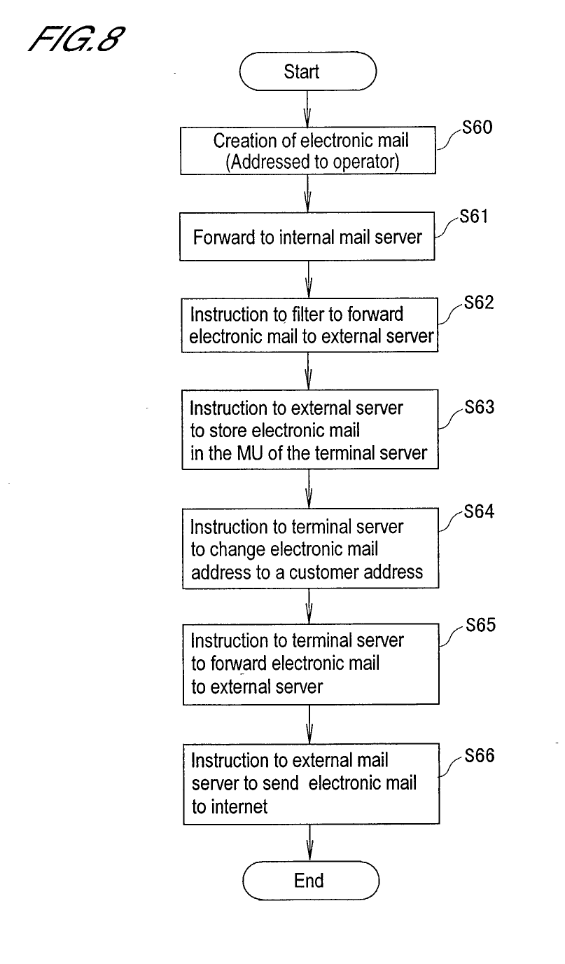

FIG. 8 is a flowchart which, in a case where a customer is notified by means of electronic mail that bank transfer processing, which has been requested by the customer, has been executed, illustrates a procedure by which the terminal 14 processes this electronic mail. The terminal 14 creates electronic mail to the effect that bank transfer processing, which has been requested by the customer, is complete (step S60), and appends the address of the operator to the electronic mail and sends same to the internal mail server 23 (step S61). The terminal 14 issues an instruction to the filter 24 within the internal mail server and sends the electronic mail to the external mail server (step S62). The electronic mail is stored in the memory unit in the web terminal server (step S63). Thereafter, the address thus appended to the electronic mail is changed by this terminal server from the address of the operator (sender) to the address of an outside party (the addressee) (step S64). Then, the electronic mail is forwarded to the external mail server 22 (step S65) and is sent to the Internet 21 for forwarding to a customer (outside party) (step S66).

Therefore, in the present embodiment, all the electronic mail which is transmitted having an external address as a result of an operator using the terminal 14, has the mail address of an operator at the bank appended thereto, and is stored in an operator mail box which has been created on the web terminal server 13. Then, the mail address of the operator at the bank, which has been appended to the electronic mail, is changed to the mail address of an external transmission partner, and the electronic mail is transmitted to the external transmission partner.

Therefore, even in the event of setting, as a result of a virus and against the will of the operator, to randomly issue electronic mail to the mail addresses, of a multiplicity of external transmission partners, which are stored in a mailing list or the like, electronic mail is not transmitted directly to the outside, but instead is stored in a mail box of the web terminal server 13. It is therefore possible for an operator to immediately detect the effects of a virus, which makes it possible to provide a suitable defense before a situation arises where, against the will of the operator, electronic mail is issued randomly, addressed to the mail addresses of a multiplicity of external transmission partners.

The present invention is not limited to or by the embodiments described, a variety of modifications being possible within the spirit of the present invention which do not depart from the scope of the present invention.

As described in detail hereinabove, according to the present invention, the terminal server transmits only data suitable for printing, with which there is no scope for penetration by a virus, to the terminal, meaning that, if, by any chance, the terminal server should be infected by a virus, the terminal is not infected by the virus. Moreover, even in the event of setting, as a result of a virus and against the will of the operator, to randomly issue electronic mail to the mail addresses, of a multiplicity of external transmission partners, which are stored in a mailing list or the like, electronic mail is not transmitted directly to the outside.

What is claimed is:

1. A remote terminal connection system, comprising:
(a) a terminal server, which has an application execution program and is connected to an external network; and
(b) a terminal, which has a GUT (Graphical User Interface) and is connected to the terminal server;
(c) wherein, in accordance with an application execution request transmitted from the terminal, the terminal server executes processing for spreadsheet or text creation, or the like, by running the application execution program, converts a table or document, or the like, which constitutes an execution result, into data suitable for printing, and transmits same to the terminal.

2. The remote terminal connection system as claimed in claim 1, wherein the terminal comprises a display unit or a printer unit, and the data suitable for printing is data in a format that has been converted into a drive interface used for the display unit or printer unit.

3. The remote terminal connection system as claimed in claim 1, wherein the application execution program is an electronic mail program, a browser program, a spreadsheet program, a word processing program, a database program, or an office suite program.

4. The remote terminal connection system as claimed in claim 2, wherein the application execution program is an electronic mail program, a browser program, a spreadsheet program, a word processing program, a database program, or an office suite program.

5. The remote terminal connection system as claimed in claim 1, wherein the terminal is connected to a business processing server having a business processing program.

6. The remote terminal connection system as claimed in claim 2, wherein the terminal is connected to a business processing server having a business processing program.

7. The remote terminal connection system as claimed in claim 3, wherein the terminal is connected to a business processing server having a business processing program.

8. The remote terminal connection system as claimed in claim 5, wherein the business processing server processes financial affairs of a financial institution.

9. A remote terminal connection system, comprising:
(a) a terminal server, which has an application execution program and is connected to an external network; and
(b) a terminal, which has a GUI and is connected to the terminal server;
(c) an external mail server, which is connected to the external network and the terminal server; and
(d) an internal mail server, which is connected to the terminal and the external mail server,
(e) wherein externally addressed electronic mail, which is transmitted from the terminal, is transmitted to the terminal server via the internal mail server and the external mail server, and is transmitted from the terminal server to the external network via the external mail server.

10. The remote terminal connection system as claimed in claim 9, wherein the terminal has an electronic mail program.

11. The remote terminal connection system as claimed in claim 9, wherein the internal mail server comprises a filter, which transmits externally addressed electronic mail to the external mail server, and the filter appends a mail address, which is transmitted to the terminal from the outside, to externally addressed electronic mail.

12. The remote terminal connection system as claimed in claim 10, wherein the internal mail server comprises a filter, which transmits externally addressed electronic mail to the external mail server, and the filter appends a mail address, which is transmitted to the terminal from the outside, to externally addressed electronic mail.

13. The remote terminal connection system as claimed in claim 9, wherein an external mail address is appended, in the terminal server, to externally addressed electronic mail.

14. The remote terminal connection system as claimed in claim 10, wherein an external mail address is appended, in the terminal server, to externally addressed electronic mail.

15. The remote terminal connection system as claimed in claim 11, wherein an external mail address is appended, to externally addressed electronic mail, in the terminal server.

16. A method, in which, by means of an instruction from a terminal, a terminal server executes processing for spreadsheet or text processing, or the like, by running an application program, and converts a table or text, or similar, which constitutes an execution result, into data suitable for printing and transmits same to the terminal, comprising:
(a) a step in which the terminal outputs an instruction to run an application program to the terminal server;
(b) a step in which the terminal server, having received the instruction from the terminal, executes processing for spreadsheet or text processing, or the like, by running an application program; and
(c) a step in which the terminal server converts a table or text, or similar, which constitutes an execution result, into data suitable for printing and transmits same to the terminal.

17. A method, in which externally addressed electronic mail, which is created using a terminal, is transmitted to a terminal server via an internal mail server and an external mail server, and is then transmitted from the terminal server to an external network via the external mail server, comprising:
(a) a step of creating externally addressed electronic mail in the terminal;
(b) a step in which the internal mail server receives externally addressed electronic mail from the terminal, and sends the electronic mail to the external mail server;
(c) a step in which the external mail server receives externally addressed electronic mail from the internal server, and sends the electronic mail to the terminal server;
(d) a step in which the terminal server receives this externally addressed electronic mail from the external mail server, and sends the electronic mail to the external mail server; and
(e) a step in which the external mail server receives this externally addressed electronic mail from the terminal server and transmits the electronic mail to the external network.

18. A method for processing viewing data supplied from a customer home page, comprising:
(a) a step in which an instruction is sent from a terminal to a server to open viewing data;
(b) a step in which the server converts viewing data into data suitable for printing, and sends same to the terminal;
(c) a step in which this viewing data is displayed (first display screen) on a display unit of the terminal;
(d) a step in which an instruction is sent from the terminal to the server to execute bank transfer processing;
(e) a step in which the server converts a bank transfer processing input screen into data suitable for printing, and sends same to the terminal;
(f) a step in which the bank transfer processing input screen is displayed (second display screen) on the display unit of the terminal;
(g) a step in which character strings that are the same as character strings of the display screen of the terminal (first display screen) are displayed by moving these like character strings to the input screen of the server (second display screen);
(h) a step in which the server is notified by the terminal that inputting to the bank transfer processing input screen is complete; and
(i) a step in which the server executes bank transfer processing after accessing the database.

19. A method for processing electronic mail addressed from a computer system terminal to an outside party outside this computer system, comprising:
(a) a step in which an operator operates a terminal to create electronic mail;
(b) a step in which a mail address of the operator is appended to the electronic mail and same is transmitted;
(c) a step in which the electronic mail is transmitted to the internal mail server;
(d) a step in which the filter of the internal mail server changes the mail address to a mail address of an operator at a bank, not only in a case where the appended mail address is “me@XXX.com”, but also in a case where a mail address of an outside party is appended to the electronic mail, and transmits this electronic mail to an external mail server;
(e) a step in which the electronic mail is transmitted from the external mail server to a web terminal server;
(f) a step in which the electronic mail is stored in an operator mail box which has been created in the memory unit of the web terminal server;
(g) a step in which the operator operates the terminal to access the web terminal server, and transmits an execution request to change the mail address of the electronic mail to a customer mail address;
(h) a step in which the appended mail address of the electronic mail is changed to a customer mail address, and the electronic mail is transmitted to the external mail server; and
(i) a step in which the electronic mail is transmitted from the external mail server to the Internet after passing through a firewall or a virus gateway, and is transmitted to a customer.

20. A remote terminal connection system program for the operation of a remote terminal connection system that comprises a terminal server, which is connected to an external network and has an application execution program, and a terminal, which is connected to this terminal server and has a GUI, which program:
(a) causes the terminal to function as means for issuing an application execution instruction to the terminal server;
(b) causes the terminal server, which has received this instruction, to function as means for executing processing for spreadsheet or document creation, or the like, by running an application execution program; and
(c) causes the terminal server to function as means for converting a table or document, or the like, which constitutes an execution result, into data suitable for printing, and transmitting same to the terminal.

21. A program for the operation of a remote terminal connection system that comprises a terminal server, which is connected to an external network and a terminal server and has an application execution program; a terminal, which is connected to this terminal server and has a GUI; and an external mail server, which is connected to the terminal server and the external network, which program:
(a) causes a terminal to function as means for creating externally addressed electronic mail;
(b) causes an internal mail server to function as means for receiving this externally addressed electronic mail from the terminal and sending this electronic mail to an external mail server;
(c) causes the external mail server to function as means for receiving this externally addressed electronic mail from the internal server and sending this electronic mail to a terminal server;
(d) causes the terminal server to function as means for receiving this externally addressed electronic mail from the external mail server and sending this electronic mail to an external mail server; and
(e) causes the external mail server to function as means for receiving this externally addressed electronic mail from the terminal server and transmitting this electronic mail to an external network.

22. A program for processing viewing data supplied from a customer home page, which program:
(a) causes the terminal to function as means for instructing the server to open viewing data;
(b) causes the server to function as means for converting viewing data into data suitable for printing, and for sending same to the terminal;
(c) causes the terminal to function as means for displaying (first display screen) this viewing data on the display unit of the terminal;
(d) causes the terminal to function as means for instructing the server to execute bank transfer processing;
(e) causes the server to function as means for converting the bank transfer processing input screen into data suitable for printing, and for sending same to the terminal;
(f) causes the bank transfer processing input screen to function as means for displaying (second display screen) on the display unit of the terminal;
(g) causes the display unit to function as means for displaying character strings that are the same as character strings of the display screen of the terminal (first display screen) by moving these like character strings to the input screen of the server (second display screen);
(h) causes the terminal to function as means for notifying the server that inputting to the bank transfer processing input screen is complete; and
(i) causes the server to function as means for executing bank transfer processing after accessing the database.

23. A program for processing electronic mail addressed from a computer system terminal to an outside party outside this computer system, which program:
(a) causes the terminal to function as means for creating electronic mail which is transmitted having an operator electronic mail address appended thereto;
(b) causes the internal mail server to function as means for receiving the electronic mail;
(c) causes the filter to function as means for changing the mail address to the mail address of an operator at a bank, not only in a case where the appended mail address is “me@XXX.com”, but also in a case where a mail address of an outside party is appended to the electronic mail, and for transmitting this electronic mail to the external mail server;
(d) causes the external mail server to function as means for transmitting this electronic mail to the web terminal server;
(e) causes the memory unit in the web terminal server to function as means for storing this electronic mail;
(f) causes the web terminal server to function as means for changing the address of the electronic mail to a customer address, in accordance with an instruction from the terminal, and causes the web terminal server to function as means for transmitting this electronic mail, which has had this address changed, to the external mail server; and
(g) causes the external mail server to function as means for transmitting this electronic mail to the customer through a firewall or a virus gateway.
